(19) United States
(12) Patent Application Publication
(10) Pub. No.: US 2026/0138078 A1
(43) Pub. Date: May 21, 2026

(54) High efficiency low energy consumption Post Combustion CO2 capture process

(71) Applicant: EIG, Inc., Sunnyvale, CA (US)

(72) Inventor: Eli Gal, Sunnyvale, CA (US)

(21) Appl. No.: 19/118,903

(22) PCT Filed: Oct. 6, 2023
(86) PCT No.: PCT/US2023/034667

§ 371 Date: Apr. 7, 2025

Related U.S. Application Data
(60) Provisional application No. 63/415,726, filed on Oct. 13, 2022.

(51) Int. Cl. B01D 53/14; C01B 32/50; C01C 1/02

(52) U.S. Cl. CPC B01D 53/1475; B01D 53/1406; B01D 53/1418; C01B 32/50; C01C 1/024

(57) ABSTRACT

An advanced process and system for post combustion CO₂ capture (PostCO₂) using CO₂—NH₃—H₂O ammoniated solution is provided. The process includes three main subsystems: CO₂ absorber operating at ambient pressure, CO₂ regenerator operating at elevated pressure and ammonia reclaimer. The system is designed for high CO₂ capture efficiency, high CO₂ loading, low heat and power consumption and regeneration of clean and high-pressure CO₂ stream. No steam is required for the regeneration and instead hot flue gas is applied directly and efficiently in the reboiler. Moderate amount of chilling is used to control ammonia emission from the absorber.

### FIELD OF THE INVENTION

The invention relates to process and system for high efficiency and low cost of absorbing CO₂ in ammoniated solution and stripping the CO₂ from CO₂-rich solution for use or for sequestration in the context of mitigating the impact of CO₂ on global warming. The invention also relates to the capture of SO₂, SO₃, NOx, HCl and HF when they are present in the gas stream.

### BACKGROUND OF THE INVENTION

Most of human-produced CO₂ emission, almost 40 billion tons per year, comes from burning fossil fuels and from industrial operation such as in the production of cement and steel. The CO₂ from such operation is present in atmospheric pressure flue gas at concentrations in the range of 4-30% and it is vented to the atmosphere with the flue gas. Capturing CO₂ from the flue gas into absorbing solution stripping it for utilization or sequestration is an important step in mitigating the impact of increased CO₂ concentration in the atmosphere on global warming.

There are currently very few operating commercial plants globally to capture CO₂ from flue gas. Most of these plants utilize a variety of amine solutions as an absorbent. The amine is expensive and degrades thermally and due to chemical reactions with oxygen and with contaminants in the gas such as SO₂, HCl, HF, NOx and particulates. The degraded material is classified as hazardous and carcinogenic waste.

The CO₂ capture efficiency of the existing processes is in the range of 50-90% and they are expensive to build and operate. Heat consumption in the reboiler is high and typically in the range of 2.5-3.0 GJ/Mton of CO₂ which amounts to 20-33% of the useful heat content of the fossil fuel. The heat source for the reboiler in amine systems is condensing steam which is generated at about 80-85% thermal efficiency adding about 0.5 GJ of heat consumption per Mton of CO₂. Power consumption for pumping the solutions, pumping and fans cooling water, flue gas and air fans and above all compressing the CO₂ is also high and in the range of 200-250 KWh/Mton of CO₂.

The PostCO₂ process is designed to address many of the issues that make exiting technology expensive and not very practical for implementation in large scale. Implementation of the process of the current invention at large scale will help reduce CO₂ emission at reasonable costs to make reduction of CO₂ emission economically viable.

### SUMMARY OF THE INVENTION

The present invention provides a process and a system to capture CO₂ from flue gas in ammoniated solution, to regenerate the solution by stripping the captured CO₂, to wash residual ammonia from the flue gas and the CO₂ stream and to recover the captured ammonia and the wash water for reuse in the system.

The absorber in the system of the current invention is designed to operate at high CO₂ capture efficiency, maximize the advantages of using the ammoniated solution as sorbent and minimize ammonia losses from the system. This is achieved by controlling the temperature profile in the absorber, the ammonia concentration of the solution and the CO₂/NH₃ mole ratio of the solution optimized for each stage of the multi-stage absorber.

The regenerator in the system of the current invention operates at pressure and it produces >99% pure CO₂ stream. Controlling the temperature and concentration profile in the regenerator produces CO₂ stream with low concentration of moisture and no need for condenser and reflux and is making compression of the CO₂ stream to the required high pressure low Capex and low energy consumption. The reboiler at the bottom of the regenerator is a gas heated heat exchanger where hot flue gas is used directly to efficiently evaporate CO₂ with smaller concentration of ammonia and water vapor from the solution. Steam can be used to complement heat duty, but in most cases, there is no need for steam and the entire heat duty of the reboiler is provided directly from the flue gas.

Residual ammonia is washed from the flue gas and from the CO₂ gas stream using water-wash system installed on top of the absorber or to its side and the top of the regenerator. The spent wash-water is directed to ammonia reclaimer which is similar to a conventional atmospheric pressure sour water stripper. In the reclaimer, the ammonia is stripped from the spent wash water and is returned to the absorber-regenerator loop and the clean water returns to the system for wash water reuse. Contaminants in the flue gas such as SO₂, SO₃, HCl, HF, NOx are captured in the system in the form of high solubility ammonium salts and can be purged from the system by purging a portion of the water in the sour water stripper.

### BRIEF DESCRIPTION OF THE DRAWINGS

FIG. 1 shows according to an exemplary embodiment of the invention a schematic of the system designed to capture CO₂ from flue gas at atmospheric pressure into ammoniated solution while using the heat content of the flue gas directly in the reboiler to strip the CO₂ from the solution. Vessel 100 is a multi-stage CO₂ absorber vessel with water-wash section on top. Vessel 200 is a multi-stage regenerator vessel to strip CO₂ from the solution with water-wash on top. Vessel 300 is an ammonia reclaimer designed to strip NH₃ from the wash water and to recover both water and ammonia for reuse in the system. Device 400 is a reboiler designed to efficiently and directly utilize the flue gas heat to strip the CO2 in the regenerator 200.

FIG. 2 shows according to an exemplary embodiment of the invention one optional design of the reboiler utilizing the flue gas heat as the heat source for stripping the CO₂.

### DETAILED DESCRIPTION

The present invention is a process and a system for capturing CO₂ from flue gas and regenerating it at elevated pressure. The process includes the following steps:
1. Cooling the flue gas by using its heat content to strip CO₂ from the ammoniated solution and removing the remaining heat from the gas.
2. High efficiency absorption of CO₂ from gas at ambient pressure into CO₂-lean ammoniated solution.
3. Regenerating the solution at elevated pressure by stripping the CO₂ from CO₂-rich ammoniated solution from the absorber using the heat content of the flue gas directly in the reboiler.
4. Washing residual ammonia from the clean gas and from the CO₂ gas streams and recovering the ammonia and the spent wash-water in a reclaimer to minimize ammonia and water losses from the system.

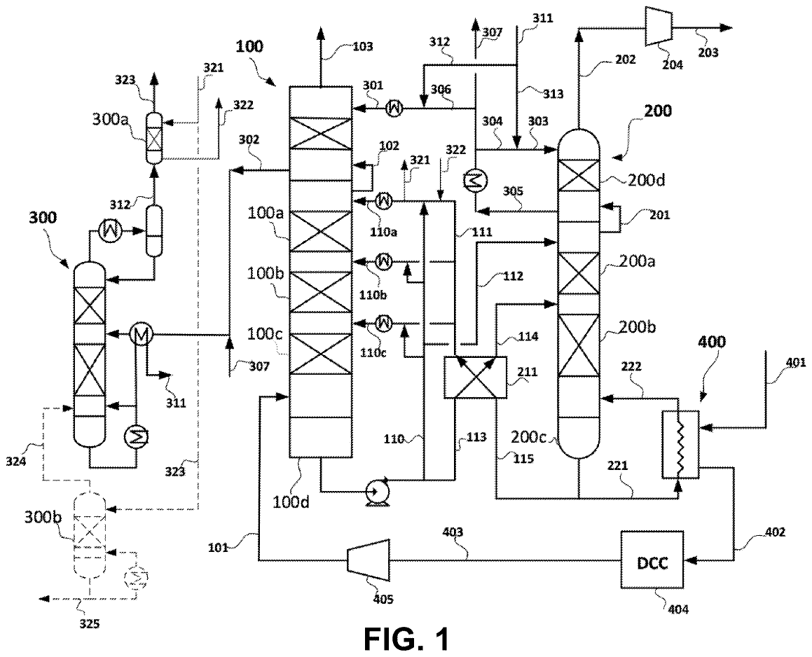

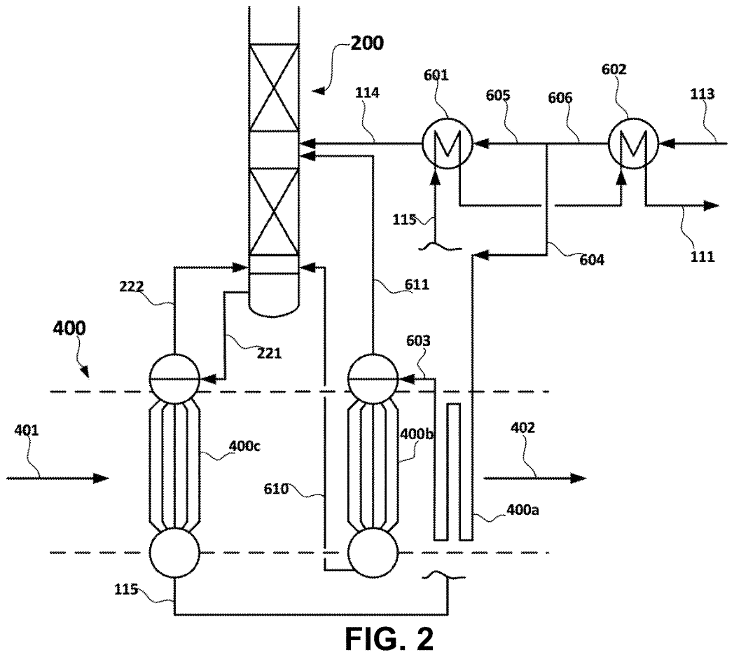

A schematic of the system is shown in FIG. 1 and a schematic of an optional configuration of the directly fired reboiler and related heat exchangers is shown in FIG. 2.

In FIG. 1 hot flue gas at elevated temperature, such as exhaust gas from gas turbine, steam generator, cement and iron plants, Stream 401, is diverted to the PostCO₂ system. Stream 401 contains sufficient heat to strip the CO₂ from the CO₂-rich solution or otherwise additional duct firing can be applied to provide the required heat. Additional heat sources, such as steam or hot oil heated in solar heaters can be used if necessary to augment the heat input to the reboiler.

The reboiler is similar to typical flue gas fired boiler for steam generation, such as HRSG, with the exception that the boiling solution is ammoniated solution, Stream 221, and the vapor in stream 222 is mainly gaseous CO₂ with low concentration of water and ammonia vapor. The temperature of flue gas exiting the reboiler, Stream 402, can be as low as 90-110 C, resulting in high efficiency utilization of the heat. Additional heat is removed from the flue gas in the heat exchanger 404 which is a gas cooler and preferably a Direct Contact Cooler (DCC). The resultant stream 403 is at ambient or sub-ambient temperature. The pressure of the flue gas is increased by the fan 405 to sufficient level for overcoming the pressure drop across the absorber. The cooled and slightly pressurized gas (typically at about 1.05-1.1 bara), stream 101, flows to the absorber.

The absorber, Vessel 100, is critical aspect of the system and it is designed for high capture efficiency of the CO₂ from the flue gas. The flue gas entering the absorber 100, stream 101, contains 4-30% CO₂ and it flows upwards through absorber stage 100c at the bottom, absorber stage 100b in the middle and absorber stage 100a at the top. More than 3 stages can be used to achieve higher efficiency at the expense of higher capital cost.

Each absorber stage has an independent solution temperature and concentration control. The temperature of the feed ammoniated solution is controlled by using coolers to remove heat from the process and generally the solution feed to the top stage, Stream 110a, is colder and utilizes chillers while the solution feed to the bottom stage, Stream 110c, is at about ambient temperature and requires cooling tower water for the temperature control.

The ammonia concentration of the ammoniated solution is in the range of 2-6 molal. The CO₂ concentration of the solution is controlled by mixing CO₂-rich solution from the bottom of the absorber, Stream 110, with CO₂-lean solution from the regenerator, Stream 111, at different ratios for each section. More than 3 absorber sections may be used to achieve higher CO₂ capture efficiency and lower ammonia emission. The CO₂ concentration of the clean gas from the absorber, Stream 102, can easily be reduced to as low as 0.2-0.4%.

The clean gas from the absorber, Stream 102, flows to the Absorber Water Wash (AWW) on top of the absorber where residual ammonia is washed and small amount of CO₂ is also captured. The AWW comprises of one or more wash sections with wash-water feed, Stream 301, at sub-ambient temperatures. The wash water feed to the AWW in stream 301 is recovered water from the NH₃ recovery system 300 and additional small amount of makeup water. Very effective wash is achieved with recovered water containing 0.05-0.1 molal of NH3(850-1700 ppmW). Recovering water at the mentioned concentration of NH₃ requires significantly less heat than typically required in sour water stripper. The spent wash water from the AWW, Stream 122, is sent for NH₃ and water recovery in system 300.

The clean gas after the AWW, Stream 103, can be designed to contain as low as 10-50 ppm NH₃ concentration and it is controlled by the amount of water wash used. As low as less than 1 ppm ammonia concentration in the clean flue gas can be achieved with mild acid wash to produce small amount of ammonium sulfate solution which can be sold as fertilizer.

As described earlier, a portion of the CO₂-rich solution from the absorber holding tank 100d is recycled as shown in FIG. 1 for mixing with CO₂-lean solution from the regenerator and for feeding the mix solution after cooling to each of the stages of the absorber. The balance of the CO₂-rich solution not used for absorber internal recycle, Streams 112 & 113, are sent to the regenerator for CO₂ stripping from the solution.

Stream 112 feeds without heating to the top of the regenerator where it flows counter currently to the rising gaseous CO₂ stream while Stream 113, flows through regenerative heat exchanger 211 where it is heated, Stream 114, and is fed to the middle of the regenerator. The heat source in the regenerative heat exchanger is hot CO₂-lean solution, Stream 115, from the bottom of the regenerator optionally augmented with heat from the flue gas, as will be explained later in conjunction with FIG. 2.

The regenerator is a multi-stage pressure vessel, Vessel 200, operating at pressure in the range of 10-50 bara. The regenerator comprises of at least two stages. The top stage 200a, is designed to cool the CO₂ gas stream and to condense and absorb NH₃ and water vapor into the cold CO₂-rich solution of stream 112. The bottom stage, stage 200b, is designed to strip CO₂ from the hot and CO₂-rich solution, Stream 114, and to absorb a portion of the NH₃ and water vapor in the CO₂ gas stream generated in the reboiler 400. The bottom of the regenerator, stage 200c, is a holding tank for the hot and CO₂-lean solution.

Heat is provided to the regenerator from the reboiler 400. The heat source to the reboiler is the flue gas in stream 401. Additional heat sources, such as steam or hot oil heated in solar heaters can be used.

The CO₂ stream exiting the regenerator at the top, Stream 201, is relatively cooled and contains low concentration of water vapor, 0.5-2%, and ammonia 100-500 ppm. The CO₂ gas stream 201 is further cooled and washed in the Regenerator Water Wash (RWW), stage 200d, by cold wash water in Stream 303. Stream 303 is a result of mixing cooled water recycled from the bottom of the RWW, Stream 304, and freshly recovered wash water, Stream 313.

Excess spent cooled wash water, Stream 307, is sent for recovery in the reclaimer with a small fraction, stream 306, is mixed with the fresh wash water, Stream 312, with the mix solution, stream 301, having a very low ammonia vapor pressure resulting in high efficiency ammonia capture and low concentration of ammonia in the clean flue gas.

Stream 303 is containing dissolved CO₂ is acidic and as a result it is very effective for ammonia wash to below 1 ppm in the clean CO₂ stream 202. Depending on pressure and temperature, stream 202 contains 0.05-0.2% moisture. Stream 202 with minimal treatment is typically compressed to 100-150 bar using, in the current invention 1-2 stage CO₂ compressor to produce stream 203.

Spent wash water, Stream 302, and Stream 307, flow to the ammonia recovery system, System 300, which operates as conventional Sour Water Stripper (SWS). The SWS operates at atmospheric plus pressure and the heat source to the reboiler is flue gas or alternatively it can use steam or hot oil. In addition to the reboiler, system 300 comprises of a stripper, a reflux and a condenser.

Recovered wash water from the SWS, Stream 311, is pumped back to the AWW and RWW as reclaimed wash water. Recovered gaseous NH3 with CO₂ and small amount of water vapor, Stream 312, exits the SWS and is sent to a small absorber column 300a. Absorber 300a utilizes cooled semi-lean solution, Stream 321, withdrawal from the main absorber-regenerator solution loop, Stream 111, after mixing with stream 110. The gaseous ammonia in stream 312 is absorbed in absorber 300a and is sent back to the main loop in stream 322. A small amount of ammonia and CO₂ together with non-condensable gas species that were dissolved in the spent water wash, mostly N₂ and O₂, is not captured in absorber 300a and it exits the system at the top and can be diverted to the AWW to combine with the flue gas.

When the raw flue gas contains contaminants such as SO₂, SO₃, NOx, HCl and HF they are captured in the ammoniated solution to produce ammonium salts. Purging the ammonium salts does not require the removal of large amount of solution. Rather, a small stripper, Stripper 300b (shown in dashed lines in FIG. 1), is installed and potentially receive a small flow of purged solvent, Stream 323, to be boiled in the stripper. The hot gas phase, Stream 324, contains mainly water vapor, vapor ammonia and CO₂, and it is injected to the bottom of the SWS. The remaining higher concentration salt solution, Stream 325, is purged from the system. In most applications, the contaminants loading is small and the stripper 300b operates intermittently. The salts in the concentrated salt solution, Stream 325, are mainly ammonia salts that can be easily converted to sodium salts by adding sodium hydroxide to stream 323. The purge system is not required with clean flue gas such as a flue gas from the clean burning of natural gas.

In FIG. 2 an optional configuration of the directly fired reboiler and related heat exchangers is shown. Embodiments of this invention are not limited to the optional design and similar designs can be applied to achieve high efficiencies.

In FIG. 2 vessel 400 is similar to Heat Recovery Steam Generator (HRSG) with the dashed lines representing the HRSG vessel (duct). Heat exchanger 400a is a two-phase counter current CO₂-rich solution heater, heat exchanger 400b is a low temperature reboiler and heat exchanger 400c is a high temperature reboiler all operating at the same controlled pressure. Heat exchangers 400b & 400c may comprise single or multiple heat exchangers in series. Instead of steam boiling in conventional HRSG, the main boiling specie in the current system is CO₂ with smaller amounts of ammonia and water vapor.

The heat source for the system is hot flue gas, Stream 401, which is used to boil the solution in high temperature reboiler 400c. Solution from the bottom of the regenerator, Stream 221, is fed to the steam drum of reboiler 400c and it circulates through the heat exchanger coils where mainly CO₂ is boiled (stripped) from the solution and flows, Stream 222, to the regenerator. Hot CO₂-lean solution, Stream 115, is discharge from the bottom drum of the reboiler 400c for heat recovery. Heat is recovered from the CO₂-lean solution in two steps, first in heat exchanger 601 and second in heat exchanger 602 to produce cooled and CO₂-lean solution Stream 111.

The flue gas exiting heat exchanger 400c is used to boil CO₂-rich solution in the low temperature reboiler 400b. The solution in reboiler 400b has higher concentration of CO₂ and thus a lower boiling temperature. A pre-heated CO₂-rich solution, Stream 603, is fed to the steam drum of the reboiler 400b and circulate through the heat exchanger coils where mainly CO₂ is boiled (stripped) from the solution and flows, Stream 611, to the regenerator. Hot and semi CO₂-lean solution, Stream 610, is discharge from the bottom liquid drum of the reboiler 400b and is sent to the bottom of the regenerator.

Additional heat recovery from the flue gas is achieved in heat exchanger 400a which is designed as a counter flow heat exchanger. Most of the useful heat of the flue gas is utilized in heat exchangers 400c, 400b and 400a. The colder flue gas exiting heat exchanger 400a, Stream 402, is typically at 90-130 degrees Celsius depending on the regenerator pressure and the dew point maximizing the use of the flue gas heat content.

The CO₂-rich solution, Stream 604 is a fraction of the total rich solution with the other fraction being stream 605. The split of the CO₂-rich solution, Stream 606, is designed at the flash point after pre-heating in heat exchanger 602.

An example of the performance of the process of the current invention will make its advantages clearer. The example and results are based on simulation using ProMax software.

A 1.1 million NM3/h flue gas stream containing 10.9% mole of CO₂ and 9.1% H2O at 390 degrees Celsius temperature, Stream 401 in FIG. 2, flows to the HRSG where it is cooled to 113 degrees Celsius and transferring a total of 391 GJ/h, equivalent to 1.83GJ/Mton of CO₂ captured, to heat and evaporate CO₂ from the ammoniated solution. The flue gas, Stream 402, is further cooled to ambient temperature in a DCC before it enters the absorber, Stream 101 in FIG. 1. The clean flue gas from the AWW, stream 103, contains 0.4% CO₂ equivalent to 97% capture efficiency. Net CO₂ loading of the solution, the difference in CO₂ content of the CO₂-rich and CO₂-lean solution, is 68 g/Kg solution. The CO₂ stream from the RWW, Stream 202, contains 0.47% water vapor and it is 99.9% CO₂ pure on dry basis.

### STATEMENTS

The invention can be characterized by one or more of the following statements individually or in combination.
1. A process and a system to capture CO2 from gas stream at atmospheric pressure into ammoniated solution and stripping the CO2 from the solution at elevated pressure to produce stream of clean gas and stream of pressurized CO2, having:
(a) Having a multi-stage CO2 absorber, wherein semi-lean ammoniated solution flows to each stage to absorb CO2 from the CO2 containing gas and to produce clean gas containing low concentration of CO2 and CO2-rich ammoniated solution.
(b) Having a gas wash stage on top of the absorber to capture residual ammonia from the clean gas stream into wash water and to produce ammonia free clean gas.
(c) Having a multi-stage pressurized CO2 regenerator, wherein the CO2 is stripped thermally and at elevated pressure from the CO2-rich solution to produce pressurized CO2 gas stream and hot CO2-lean solution.
(d) Having a wash stage on top of the CO2 regenerator to capture residual ammonia from the CO2 stream into wash water and to produce ammonia free CO2 stream.
(e) Having a reboiler at the bottom of the regenerator, wherein the CO2 is stripped from the ammoniated solution by heat provided from the gas.
(f) having a series of heat exchangers, wherein the CO2-rich solution is split to the series of heat exchangers, wherein output of the series of heat exchangers feeds into the stripper vessel at different stages of the stripper vessel, and wherein the series of heat exchangers is designed for heating the CO2-rich solution using the heat content of the CO2-lean solution and of the gas stream.
(g) Having a spent water wash reclaimer, wherein ammonia is stripped from the spent wash water to produce NH3 containing gas stream and clean wash water and wherein a second reboiler is optionally installed to produce ammonia free water for contaminants purging from the system.
2. The absorber where a semi-lean CO2-rich solution flows to each stage of the multi-stage CO2 absorber and where the concentration of the semi-lean solution is controlled by mixing CO2-rich solution from the bottom of the absorber and CO2-lean solution from the regenerator.
3. The absorber where the temperature of the ammoniated solution flowing to each stage is controlled by a heat exchanger cooler.
4. The gas wash stage on top of the absorber, where the temperature of the wash water is controlled and cooled to below ambient temperature.
5. The CO2 regenerator where an unheated fraction of the CO2-rich solution flows to the upper stage of the regenerator and the balance is preheated and flows to the lower stages of the regenerator.
6. The gas wash stage on top of the regenerator where the temperature of the feed wash water is cooled to close to ambient temperature.
7. The reboiler where a portion or all of the heat for evaporating the CO2 from the ammoniated solution is provided and exchanged directly from the CO2 containing gas.
8. The spent wash water reclaimer where the ammonia in the ammonia containing gas is captured by absorption into semi-lean solution from the process and pumped back to the process and wherein the clean water wash is recycled to the washing stages.
9. The spent wash water reclaimer where the second reboiler evaporates additional ammonia from portion of the solution to produce ammonia free solution for purging contaminants from the system.

What is claimed is:

1. A method for capturing CO₂ from a CO₂ containing gas stream at atmospheric pressure into an ammoniated solution and stripping the CO₂ from the ammoniated solution at an elevated pressure to produce a stream of clean gas and a stream of pressurized CO₂, comprising:
(a) flowing a semi-lean ammoniated solution to each stage of a multi-stage CO₂ absorber to absorb CO₂ from the CO₂ containing gas and producing a clean gas stream containing a low concentration of CO₂ and a CO₂-rich ammoniated solution;
(b) capturing residual ammonia from the clean gas stream and producing an ammonia free clean gas;
(c) thermally stripping CO₂, using a multi-stage pressurized CO₂ regenerator at an elevated pressure, from the CO₂-rich ammoniated solution for producing pressurized a CO₂ gas stream and a hot CO₂-lean solution;
(d) capturing residual ammonia from the CO₂ gas stream and producing an ammonia free CO₂ stream;
(e) thermally stripping CO₂, using a reboiler, from the CO₂-rich ammoniated solution;
(f) splitting the CO₂ solution over a series of heat exchangers, and wherein the series of heat exchangers are designed for heating the CO₂ solution using a heat content of the hot CO₂-lean solution and of the CO₂ gas stream; and
(g) reclaiming the ammonia.
